(19) United States
(12) Patent Application Publication
(10) Pub. No.: US 2026/0305645 A1
(43) Pub. Date: Oct. 8, 2026

(54) PARAXANTHINE COFFEE

(71) Applicant: NANJING NUTRABUILDING BIO-TECH CO., LTD., Nanjing (CN)

(72) Inventors: Kylin LIAO, Nanjing (CN); Shawn WELLS, Frisco, TX (US)

(21) Appl. No.: 19/682,507

(22) Filed: May 20, 2026

Related U.S. Application Data
(63) Continuation-in-part of application No. PCT/CN2024/132562, filed on Nov. 18, 2024.

(30) Foreign Application Priority Data
Nov. 22, 2023 (WO) PCT/CN2023/133314

(51) Int. Cl. A23F 5/14

(52) U.S. Cl. CPC A23F 5/145; A23F 2200/00

(57) ABSTRACT

The invention provides a paraxanthine coffee and a preparation method thereof, which solves the side effects of coffee, such as anxiety, irritability, trembling, nervousness, increased urination and the like, and brings extremely high applicability to users. The paraxanthine coffee of the invention has no side effects at all, and can be widely used in the fields of relieving the stress or anxiety, relieving fatigue, restoring physical strength, invigorating spirit, helping digestion, losing weight and the like in a subject.

### CROSS REFERENCE TO RELATED APPLICATION

This application is a continuation-in-part application of International Patent Application No. PCT/CN2024/132562, filed on Nov. 18, 2024, which claims the priority of the International Application No. PCT/CN2023/133314, filed on Nov. 22, 2023, the contents of all of which are incorporated herein by reference in their entirety.

### FIELD OF THE INVENTION

The invention belongs to the technical field of food or beverage, and particularly relates to a paraxanthine coffee and a preparation method thereof.

### BACKGROUND OF THE INVENTION

Coffee and coffee beverage are very popular. However, coffee and coffee beverage can cause many consumers to experience adverse side effects, such as anxiety, nervousness, irritability, stress and trembling. Therefore, there is a need for coffee substitutes that can provide the benefits of coffee and have no or at least fewer side effects associated with coffee. Paraxanthine (also known as 1,7-dimethylxanthine) is a dimethyl derivative of xanthine. Paraxanthine is observed in nature as a metabolite of caffeine in animals and humans. Caffeine is the most studied and widely used stimulant in coffee and tea products so far. Although the chemical structure is very similar, paraxanthine has an improvement effect compared with caffeine, and there is no adverse side effect of caffeine. Therefore, paraxanthine has important research value and broad market prospects in the field of coffee substitution.

### SUMMARY OF THE INVENTION

In order to solve the above problems, the invention provides a paraxanthine coffee and a preparation method thereof, which solves the side effects of coffee, such as anxiety, irritability, trembling, nervousness, increased urination and the like, and brings extremely high applicability to users. The paraxanthine coffee of the invention has no side effects at all, and can be widely used in the fields of relieving the stress or anxiety, relieving fatigue, restoring physical strength, invigorating spirit, helping digestion, losing weight and the like in a subject.

In one aspect, the present invention provides a paraxanthine coffee comprising 0.1% (w/w) to 10% (w/w) of paraxanthine and less than 1% (w/w) of theobromine and/or theophylline.

In some embodiments, the paraxanthine coats or partially coats coffee. Paraxanthine includes anhydrous paraxanthine, paraxanthine salt and/or paraxanthine hydrate, and paraxanthine salt includes but is not limited to paraxanthine magnesium salt, paraxanthine calcium salt, paraxanthine sodium salt and paraxanthine potassium salt, etc.

In some embodiments, the paraxanthine coating thickness can range from 0.01 mm~2 mm, 0.01 mm~1.8 mm, 0.01 mm~1.5 mm, 0.01 mm~1 mm, 0.01 mm~0.5 mm, 0.01 mm~0.2 mm, 0.05 mm~0.5 mm, 0.05 mm~1 mm, 0.05 mm~1.5 mm, 0.05 mm~2 mm.

In some embodiments, the paraxanthine coffee comprises 0.1% (w/w) to 5% (w/w) of paraxanthine and less than 0.1% (w/w) of theobromine and/or theophylline.

In some embodiments, the paraxanthine coffee comprises 0.1% (w/w) to 5% (w/w) of paraxanthine and less than 0.05% (w/w) of theobromine and/or theophylline. The amount of the paraxanthine in the paraxanthine coffee is between about 0.1% and about 10% w/w, or about 0.2% to 10% w/w, or about 0.5% to 10% w/w, or about 1% to 10% w/w, or about 0.2% to 8% w/w, or about 0.5% to 8% w/w, or about 0.2% to 5% w/w, or about 0.5% to 5% w/w, or about 1% to 5% w/w, or about 0.1% to 8% w/w, or about 0.1% to 5% w/w. The content of the theobromine and/or theophylline can be less than 0.1% w/w, or less than 0.05% w/w, or less than 0.01% w/w.

In some embodiments, the paraxanthine coffee has a particle size of 10-30 meshes, preferably 10-20 meshes.

In some embodiments, the paraxanthine coffee may be a paraxanthine coffee bean or a paraxanthine coffee beverage.

In some embodiments, the paraxanthine coffee further comprises 0.01%~1% coffee oil.

In some embodiments, the paraxanthine coffee further comprises 0.01%~2% of medium-chain triglycerides.

In one aspect, the present invention provides a method for relieving the stress or anxiety in a subject, which comprises administering the paraxanthine coffee of the invention to the subject.

In one aspect, the present invention provides a method for relieving fatigue, restoring physical strength, invigorating spirit in a subject, which comprises administering the paraxanthine coffee of the invention to the subject.

In one aspect, the present invention provides a method for improving exercise performance in a subject, which comprises administering the paraxanthine coffee of the invention to the subject, it can be administered before, during or after exercise.

In one aspect, the present invention provides a method for helping digestion, losing weight in a subject, which comprises administering the paraxanthine coffee of the invention to the subject.

In another aspect, the present invention provides a method for preparing paraxanthine coffee comprising the following steps: decocting coffee beans to remove substances such as theobromine and theophylline from the coffee beans; weighing a formulated amount of paraxanthine and preparing it into a suspension or solution; roasting a formulated amount of the coffee beans, followed by spray-coating the suspension or solution of the formulated amount of paraxanthine onto the coffee beans, and then drying to obtain paraxanthine coffee beans.

In some embodiments, an appropriate binder, such as one or more of pectin, xanthan gum, Carrageenan, guar gum, Arabic gum, hydroxymethyl cellulose, and hydroxypropyl methylcellulose, may be added to the paraxanthine suspension or solution.

In some embodiments, the coffee beans are roasted at a temperature ranging from 160°C to 260°C.

In some embodiments, the equipment used for the spray-coating is a high-efficiency coating machine (pan) and/or a multifunctional fluid bed.

In some embodiments, the paraxanthine coffee can also be spray-coated with coffee oil and/or medium-chain triglycerides, or the prepared paraxanthine coffee can be pulverized and compounded with other auxiliary materials to prepare a paraxanthine coffee beverage.

If the coating thickness is less than 0.01 mm, the loading of paraxanthine is insufficient, and it is difficult to achieve effective dose during brewing, and the excessively thin coating layer is easy to fall off or be uneven during transportation, grinding or brewing of coffee beans. If the coating thickness is greater than 2 mm, the particle size and weight of coffee beans will be significantly increased, which will lead to the decrease of the dissolution rate of paraxanthine during brewing, and it is necessary to extend the extraction time, and the excessively thick coating layer will also mask the flavor of coffee itself. The selected range can not only ensure the effective loading of paraxanthine, but also realize rapid and full dissolution under the conditions of conventional coffee grinding and brewing, and at the same time, it will not affect the appearance, aroma and taste of coffee beans.

### BRIEF DESCRIPTION OF THE DRAWINGS

FIGS. 1 and 2 show the changes in reaction time for the Go task and the No-Go task, respectively.

FIG. 3 shows the results of the running test of two groups of subjects.

FIG. 4 shows the changes in the two groups of subjects' fat oxidation rate.

### DETAILED DESCRIPTION OF THE INVENTION

In the Summary Section above and the Detailed Description Section, and the claims below, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

As used herein, the term “or” is meant to include both “and” and “or.” In other words, the term “or” may also be replaced with “and/or.”

As used herein, the singular forms “a,” “an” and “the” are intended to include the plural forms as well, unless the context clearly indicates otherwise.

As used herein, the term “comprise” or “include” or their conjugations, refer to a situation where said terms are used in their non-limiting sense to mean that items following the word are included, but items not specifically mentioned are not excluded. It also encompasses the more limiting verb ‘to consist essentially of’ and ‘to consist of’.

As used herein, the term "adsorption" refers to the process by which a first substance forms a thin film on the surface of a second substance. For example, by adsorbing paraxanthine into coffee beans, it means that paraxanthine is adsorbed onto the coffee beans.

As used herein, the term “effective amount” refers to the amount required to achieve the effect as taught herein.

As used herein, the term "dietetically or physiologically acceptable" refers to substances that are generally safe, non-toxic, and free from biologically or otherwise undesirable effects, and are acceptable for pharmaceutical, cosmetic, or food (human or animal) use, particularly for food use. “Dietetically or physiologically acceptable salt” of a compound is taken to designate salts that are physiologically acceptable, as defined above, and which have the desired activity (pharmacological, cosmetic or food) of the parent compound.

### Examples

In the present disclosure, unless otherwise specified, scientific and technical terms used herein have the meanings commonly understood by those skilled in the art. Moreover, the laboratory operation steps used herein are all routine steps widely used in the corresponding fields.

The raw materials or reagents used in the present disclosure are commercially available unless otherwise specified. All reagents are commercial grade or food grade and used according to the received standards.

Coffee beans used in the present invention that contain no or less theobromine and theophylline can be prepared and obtained by known methods, which can be raw or green, or can be baked when paraxanthine is added. Paraxanthine used in the invention includes anhydrous paraxanthine, paraxanthine salt and/or paraxanthine hydrate, and suitable paraxanthine salt includes but is not limited to paraxanthine magnesium salt, paraxanthine calcium salt, paraxanthine sodium salt and paraxanthine potassium salt, etc.

Paraxanthine coffee of the present invention is produced by adding paraxanthine to coffee beans containing no or less theobromine and theophylline. In order to add paraxanthine to coffee beans by adsorption, unbaked or roasted coffee beans are coated with a concentrated solution of paraxanthine on the outer surface of the coffee beans, and then the carrier solvent is evaporated, leaving a thin paraxanthine layer on the outer surface of the coffee beans. During the adsorption process described herein, part of paraxanthin and/or carrier solvent can also be absorbed into the interior of beans. Therefore, those skilled in the art will recognize that absorption and adsorption can occur simultaneously. Suitable carrier solvents for paraxanthine adsorption include ethanol, water or ethanol aqueous solution.

Coffee beans containing no or less theobromine and theophylline can be prepared by decoction.

The paraxanthine coffee of the present invention includes but is not limited to brewed paraxanthine coffee (including hot brewed and cold brewed paraxanthine coffee), concentrated paraxanthine coffee, paraxanthine coffee beverage, instant paraxanthine coffee, ready-to-drink paraxanthine coffee beverage, roasted paraxanthine coffee beverage, paraxanthine milkshake, paraxanthine energy beverage, paraxanthine soda water, paraxanthine weight-loss beverage, paraxanthine supplement beverage and paraxanthine sports beverage.

The paraxanthine content in the paraxanthine coffee of the present invention can be expressed as paraxanthine weight/paraxanthine coffee weight. The amount of paraxanthine in the paraxanthine coffee is an amount sufficient to provide a desired positive effect to a consumer during brewing without undesirable side effects, for example, in the range of about 0.1% w/w, or about 10 mg paraxanthine/10 g paraxanthine coffee, to about 10% w/w, or to about 1000 mg paraxanthine/10 g paraxanthine coffee. The amount of paraxanthine in the paraxanthine coffee disclosed by the invention is between about 0.1% and about 10% w/w, or about 0.2% to 10% w/w, or about 0.5% to 10% w/w, or about 1% to 10% w/w, or about 0.2% to 8% w/w, or about 0.5% to 8% w/w, or about 0.2% to 5% w/w, or about 0.5% to 5% w/w, or about 1% to 5% w/w, or about 0.1% to 8% w/w, or about 0.1% to 5% w/w.

The paraxanthine coffee provided by the present invention comprises 0.1% (w/w), 0.2% (w/w), 0.3% (w/w), 0.4% (w/w), 0.5% (w/w), 0.6% (w/w), 0.7% (w/w), 0.8% (w/w), 0.9% (w/w), 1.0% (w/w), 1.2% (w/w), 1.4 % ( w/w), 1.5% ( w/w), 1.6% ( w/w), 1.8% ( w/w), 2.0% ( w/w), 2.2% ( w/w), 2.4% ( w/w), 2.6% (w/w), 2.8% (w/w), 2.9% (w/w), 3.0% (w/w), 3.2% (w/w), 3.4% (w/w), 3.6% (w/w), 3.8% (w/w), 4% (w/w), 4.2% (w/w), 4.4% (w/w), 4.6% (w/w), 4.8% (w/w), 5.0% (w/w), 5.5% (w/w), 6.0% (w/w), 6.5% (w/w), 7.0% (w/w), 7.5% (w/w), 8.0% (w/w), 8.5% (w/w), 9.0% (w/w), 9.5% (w/w), or about 10% (w/w) of paraxanthine, a salt thereof or a hydrate thereof.

The content of theobromine and theophylline in the present invention can be expressed as the weight of theobromine or theophylline/the weight of paraxanthine coffee. The content of theobromine and/or theophylline can be less than 1% w/w, or less than 0.5% w/w, or less than 0.25% w/w, or less than 0.1% w/w, or less than 0.05% w/w, or less than 0.01% w/w.

Paraxanthine coated or partially coated coffee of the present invention can have a coating thickness ranging from 0.01 mm~2 mm, 0.01 mm~1.8 mm, 0.01 mm~1.5 mm, 0.01 mm~1 mm, 0.01 mm~0.5 mm, 0.01 mm~0.2 mm, 0.05 mm~0.5 mm, 0.05 mm~1 mm, 0.05 mm~1.5 mm, 0.05 mm~2 mm.

The paraxanthine coffee of the present invention may further comprise 0.01%~1% coffee oil, which can enhance the aroma. Because the aroma of coffee beans will be lost in the preparation process, adding some coffee oil can make the aroma consistent with the original coffee beans, and even make the smell more intense and attractive. The paraxanthine coffee of the present invention may further comprise 0.01%~2% MCT oil (medium-chain triglycerides), which can make the appearance of paraxanthine coffee glossy. Because the surface of the paraxanthine-coated coffee bean is uneven and the color is different from that of the original coffee bean, adding a small amount of MCT oil makes the paraxanthine coffee bean appear more oil-moistened.

Coffee contains caffeine, which stimulates the central nervous system, promotes the breakdown of liver glycogen, and raises blood sugar levels. When consumed in moderation, it can temporarily energize a person and sharpen their thinking. When consumed after exercise, it helps relieve fatigue, restore physical strength, and invigorate spirit. Coffee also contains certain acidic substances that promote gastric acid secretion, aid gastrointestinal motility, alleviate symptoms of indigestion, help digestion, and contribute to weight loss. As a result, coffee has become the favorite among young people. However, it has some side effects, such as anxiety, irritability, trembling, nervousness, and increased urination, etc. The Paraxanthine Coffee of the present invention contains no or less theobromine and theophylline, does not cause undesirable side effects for consumers, and offers good adaptability for consumers.

Paraxanthine coffee can increase human excitability, relieve fatigue, and improve brain functions, including mood, memory, alertness, and reaction time, etc. Moreover, compared with other coffees, paraxanthine coffee does not cause caffeine addiction, offering users extremely high applicability. The magnesium and potassium it contains help insulin regulate blood sugar levels, reduce cravings for sweets and snacks, assist the human body in burning fat, breaking down body fat, and thus contribute to weight loss. The paraxanthine coffee contains the antioxidant tannic acid, which not only fights against cardiovascular diseases but also improves skin condition, delays skin aging, promotes skin metabolism, and reduces the occurrence of dark circles. Niacin in the paraxanthine coffee provides B vitamins, and the paraxanthine coffee also contains free fatty acids, which can boost metabolism, aid gastrointestinal digestion, promote fat breakdown, and thereby alleviate constipation.

Example 1 P reparation of coffee beans containing no or less theobromine and theophylline

The preparation method is as follows:
(1) Decoction: Weigh an appropriate amount of raw coffee beans, add water, and decoct at 80-120 ℃ for 1-4 h. Then remove and air-dry for later use.
(2) Place the decocted coffee beans from step (1) into a coffee roaster and, at temperatures ranging from 160 ℃ to 260 ℃, prepare lightly roasted, medium roasted, and darkly roasted coffee beans.

Example 2 Preparation by paraxanthine adsorption

The preparation method is as follows:
(1) Weighing: Weigh pectin, paraxanthine, and coffee beans containing no or less theobromine and theophylline according to the formulation, for later use
(2) Preparation of paraxanthine suspension: Sequentially add formulated amounts of pectin and paraxanthine to an appropriate amount of water, and stir for 15 min, for later use.
(3) Adsorption: Place formulated amount of coffee beans containing no or less theobromine and theophylline into a high-efficiency coating pan and preheat them. Set the parameters as follows: inlet air volume: 230 m³/h, inlet air temperature: 65° C., bed temperature: 45° C., main spindle speed: 12 rpm, negative pressure: -30 MPa. Once the bed temperature reaches 45° C., connect the tank containing the paraxanthine suspension to a peristaltic pump and begin spray adsorption (atomization pressure: 1.30 MPa, needle pressure: 1.00 MPa, peristaltic pump speed: 2~3 rpm). After the adsorption is complete, continue drying for 20 min. After drying, discharge the material.

Example 3 Preparation by paraxanthine adsorption

The preparation method is as follows:
(1) Weighing: Weigh 0.2% Arabic gum, 1.0% paraxanthine, and 98.8% coffee beans containing no or less theobromine and theophylline according to the formulation, for later use.
(2) Preparation of paraxanthine suspension: Sequentially add formulated amounts of Arabic gum and paraxanthine to an appropriate amount of water, and stir for 15 min, for later use.
(3) Adsorption: Place formulated amount of coffee beans containing no or less theobromine and theophylline into a high-efficiency coating pan and preheat them. Set the parameters as follows: inlet air volume: 210 m³/h, inlet air temperature: 60° C., bed temperature: 40° C., main spindle speed: 10 rpm, negative pressure: -25 MPa. Once the bed temperature reaches 40° C., connect the tank containing the paraxanthine suspension to a peristaltic pump and begin spray adsorption (atomization pressure: 1.20 MPa, needle pressure: 1.00 MPa, peristaltic pump speed: 2 rpm). After the adsorption is complete, continue drying for 25 min. After drying, discharge the material.

Example 4 Preparation by paraxanthine adsorption

The preparation method is as follows:
(1) Weighing: Weigh 0.2% guar gum, 1.0% paraxanthine, and 98.8% coffee beans containing no or less theobromine and theophylline according to the formulation, for later use.
(2) Preparation of paraxanthine suspension: Sequentially add formulated amounts of guar gum and paraxanthine to an appropriate amount of water, and stir for 15 min, for later use.
(3) Adsorption: Place formulated amount of coffee beans containing no or less theobromine and theophylline into a high-efficiency coating pan and preheat them. Set the parameters as follows: inlet air volume: 210 m³/h, inlet air temperature: 60° C., bed temperature: 40° C., main spindle speed: 10 rpm, negative pressure: -25 MPa. Once the bed temperature reaches 40° C., connect the tank containing the paraxanthine suspension to a peristaltic pump and begin spray adsorption (atomization pressure: 1.20 MPa, needle pressure: 1.00 MPa, peristaltic pump speed: 2 rpm). After the adsorption is complete, continue drying for 25 min. After drying, discharge the material.

Example 5 Preparation by paraxanthine adsorption

The preparation method is as follows:
(1) Weighing: Weigh 0.2% Carrageenan, 1.0% paraxanthine, and 98.8% coffee beans containing no or less theobromine and theophylline according to the formulation, for later use.
(2) Preparation of paraxanthine suspension: Sequentially add formulated amounts of Carrageenan and paraxanthine to an appropriate amount of water, and stir for 15 min, for later use.
(3) Adsorption: Place formulated amount of coffee beans containing no or less theobromine and theophylline into a high-efficiency coating pan and preheat them. Set the parameters as follows: inlet air volume: 220 m³/h, inlet air temperature: 60° C., bed temperature: 40° C., main spindle speed: 10 rpm, negative pressure: -25 MPa. Once the bed temperature reaches 40° C., connect the tank containing the paraxanthine suspension to a peristaltic pump and begin spray adsorption (atomization pressure: 1.20 MPa, needle pressure: 1.00 MPa, peristaltic pump speed: 2 rpm). After the adsorption is complete, continue drying for 25 min. After drying, discharge the material.

Example 6 Preparation by paraxanthine adsorption

The preparation method is as follows:
(1) Weighing: Weigh 0.5% Carrageenan, 1.0% paraxanthine, and 98.5% coffee beans containing no or less theobromine and theophylline according to the formulation, for later use.
(2) Preparation of paraxanthine suspension: Sequentially add formulated amounts of Carrageenan and paraxanthine to an appropriate amount of water, and stir for 20 min, for later use.
(3) Adsorption: Place formulated amount of coffee beans containing no or less theobromine and theophylline into a high-efficiency coating pan and preheat them. Set the parameters as follows: inlet air volume: 220 m³/h, inlet air temperature: 65° C., bed temperature: 45° C., main spindle speed: 12 rpm, negative pressure: -30 MPa. Once the bed temperature reaches 45° C., connect the tank containing the paraxanthine suspension to a peristaltic pump and begin spray adsorption (atomization pressure: 1.30 MPa, needle pressure: 1.00 MPa, peristaltic pump speed: 3 rpm). After the adsorption is complete, continue drying for 20 min. After drying, discharge the material.

Example 7 Preparation by paraxanthine adsorption

The preparation method is as follows:
(1) Weighing: Weigh 0.5% Carrageenan, 2.0% paraxanthine, and 97.5% coffee beans containing no or less theobromine and theophylline according to the formulation, for later use.
(2) Preparation of paraxanthine suspension: Sequentially add formulated amounts of Carrageenan and paraxanthine to an appropriate amount of water, and stir for 20 min, for later use.
(3) Adsorption: Place formulated amount of coffee beans containing no or less theobromine and theophylline into a high-efficiency coating pan and preheat them. Set the parameters as follows: inlet air volume: 220 m³/h, inlet air temperature: 65° C., bed temperature: 45° C., main spindle speed: 12 rpm, negative pressure: -30 MPa. Once the bed temperature reaches 45° C., connect the tank containing the paraxanthine suspension to a peristaltic pump and begin spray adsorption (atomization pressure: 1.30 MPa, needle pressure: 1.00 MPa, peristaltic pump speed: 3 rpm). After the adsorption is complete, continue drying for 20 min. After drying, discharge the material.

Example 8 Alertness- enhancing effects of paraxanthine coffee

This double-blind, randomized study recruited 20 healthy subjects (age 22.5 ± 1.5 years, height 173.4 ± 6.7 cm, body weight 63.4 ± 15.6 kg), who were randomly divided into two groups: one group received the paraxanthine coffee beverage (n=10), and the other group was assigned as the placebo group (n=10). There were no significant differences between the two experimental groups in terms of age or years of education. All participants who took part in the study completed written informed consent. Prior to testing, all participants had abstained from caffeine for at least 48 hours. Other exclusion criteria included: (1) history of traumatic brain injury, defined as loss of consciousness lasting more than 30 minutes; (2) brain tumor or stroke; (3) any medical condition that could increase risk upon exposure to caffeine; (4) significant impairment of vision, hearing, and/or hand mobility; (5) current use of any amount of illegal drugs; (6) smokers (or those who had smoked/used nicotine products within 6 months prior to the study start); (7) participants who consumed two or more standard alcoholic beverages per day.

Subjects were randomly assigned to receive either a placebo or a paraxanthine coffee beverage (containing 100 mg of paraxanthine). The placebo was identical to the active beverage in volume (300 mL) and flavor, but without the active ingredient (paraxanthine). Sixty minutes after consuming, changes in the subjects' reaction time were measured using a Go/No-Go task, which assessed the subjects' ability to maintain alertness and attention and to respond to visual stimuli.

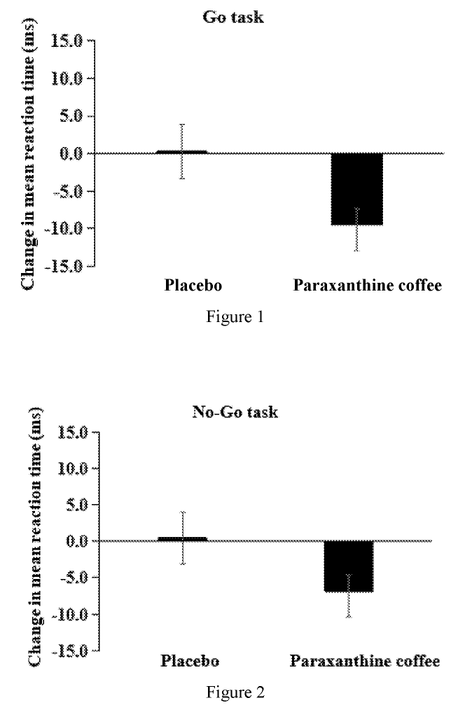

FIGS. 1 and 2 show the changes in reaction time for the Go task and the No-Go task, respectively. The changes in mean reaction time for subjects who received the placebo were 0.11 ms and 0.43 ms in the Go task and the No-Go task, respectively; for subjects who received the paraxanthine coffee beverage, the changes in mean reaction time were -9.53 ms and -6.86 ms in the Go task and the No-Go task, respectively, indicating that the paraxanthine coffee beverage can significantly reduce the subjects' mean reaction time. Therefore, the paraxanthine coffee beverage can enhance attention and has alertness-enhancing effects.

Example 9 Paraxanthine coffee e nhances exercise performance

This study employed a randomized, double-blind, placebo-controlled, parallel-group design. The primary hypothesis was that the paraxanthine coffee beverage (containing 100 mg of paraxanthine) would enhance exercise performance in subjects compared to an identical dose of a placebo beverage.

This double-blind, randomized study recruited 20 healthy subjects (age 22.5 ± 1.5 years, height 173.4 ± 6.7 cm, body weight 63.4 ± 15.6 kg), who were randomly divided into two groups: one group received the paraxanthine coffee beverage (n=10), and the other group was assigned as the placebo group (n=10). There was no significant difference between the two groups of subjects in the running performance test (2000 meters). All participants who took part in the study completed written informed consent and filled out questionnaires on health history, dietary history, and physical activity. All participants who took part in the study completed written informed consent. Other exclusion criteria included: (1) any medical condition that could increase risk upon exposure to caffeine; (2) current use of any amount of illegal drugs; (3) smokers (or those who had smoked/used nicotine products within 6 months prior to the study start); (4) participants who consumed two or more standard alcoholic beverages per day.

Subjects were randomly assigned to receive either a placebo or a paraxanthine coffee beverage (containing 100 mg of paraxanthine). The placebo was identical to the active beverage in volume (300 mL) and flavor, but without the active ingredient (paraxanthine). Prior to testing, all participants fasted for 8 hours and then consumed 300 mL of either the placebo or the paraxanthine coffee beverage on an empty stomach. Thirty minutes after consuming, a 2000-meter running test was conducted, and the subjects' running time was recorded to evaluate changes in their exercise performance.

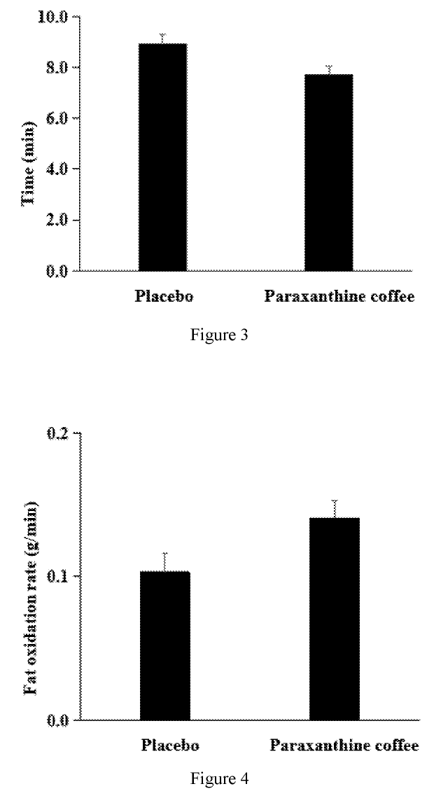

FIG. 3 shows the results of the 2000-meter running test. Subjects who received the placebo had a running time of 8.9 minutes, whereas those who received the paraxanthine coffee had a running time of 7.8 minutes. These results indicate that the paraxanthine coffee beverage can significantly reduce running time compared to placebo. Therefore, the paraxanthine coffee beverage can enhance exercise performance.

Example 10 Weight loss effect of paraxanthine coffee

This double-blind, randomized study recruited 20 healthy subjects (age 22.5 ± 1.5 years, height 173.4 ± 6.7 cm, body weight 63.4 ± 15.6 kg), who were randomly divided into two groups: one group received the paraxanthine coffee beverage (n=10), and the other group was assigned as the placebo group (n=10). All participants who took part in the study completed written informed consent. Prior to testing, all participants had abstained from caffeine for at least 48 hours. Other exclusion criteria included:
(1) history of traumatic brain injury, defined as loss of consciousness lasting more than 30 minutes;
(2) brain tumor or stroke;
(3) any medical condition that could increase risk upon exposure to caffeine;
(4) current use of any amount of illegal drugs;
(5) smokers (or those who had smoked/used nicotine products within 6 months prior to the study start);
(6) participants who consumed two or more standard alcoholic beverages per day.

Subjects were randomly assigned to receive either a placebo or a paraxanthine coffee beverage (containing 100 mg of paraxanthine). The placebo was identical to the active beverage in volume (300 mL) and flavor, but without the active ingredient (paraxanthine). Sixty minutes after consuming, exhaled gas from the participants was collected using a respiratory gas analysis system to determine the subjects' fat oxidation rate.

FIG. 4 shows the changes in the subjects' fat oxidation rate. The fat oxidation rate in subjects who received the placebo was 0.10 g/min at 60 minutes post-consumption, whereas that in subjects who received the paraxanthine coffee beverage was 0.14 g/min at 60 minutes post-consumption, indicating that the paraxanthine coffee beverage can significantly increase the subjects' fat oxidation rate. Therefore, the paraxanthine coffee beverage can accelerate fat metabolism and has weight-loss benefits.

Although specific embodiments and examples of the present disclosure have been illustrated herein, it will be appreciated by those skilled in the art that any modifications and variations can be made without departing from the spirit of the present disclosure. The examples and illustrations above are not intended to limit the scope of the present disclosure. Any combination of embodiments of the present disclosure, along with any obvious their extension or analogs, are within the scope of the present disclosure. Further, it is intended that the present disclosure encompass any arrangement, which is calculated to achieve that same purpose, and all such variations and modifications fall within the scope of the appended claims.

What is claimed is:

1. A paraxanthine coffee comprising 0.1% (w/w) to 10% (w/w) of paraxanthine and less than 1% (w/w) of theobromine and/or theophylline.

2. The paraxanthine coffee of claim 1, wherein the paraxanthine coats or partially coats coffee.

3. The paraxanthine coffee of claim 1, wherein the paraxanthine coating thickness ranges from 0.01 mm~2 mm.

4. The paraxanthine coffee of claim 1, wherein the paraxanthine coating thickness ranges from 0.05 mm~1 mm.

5. The paraxanthine coffee of claim 1, wherein the paraxanthine coffee comprises 0.1% (w/w) to 5% (w/w) of paraxanthine and less than 0.1% (w/w) of theobromine and/or theophylline.

6. The paraxanthine coffee of claim 1, wherein the paraxanthine coffee comprises 0.1% (w/w) to 5% (w/w) of paraxanthine and less than 0.05% (w/w) of theobromine and/or theophylline.

7. The paraxanthine coffee of claim 1, wherein the paraxanthine coffee has a particle size of 10-30 meshes.

8. The paraxanthine coffee of claim 1, wherein the paraxanthine coffee has a particle size of 10-20 meshes.

9. The paraxanthine coffee of claim 1, wherein the paraxanthine coffee is a paraxanthine coffee bean or a paraxanthine coffee beverage.

10. The paraxanthine coffee of claim 1, wherein the paraxanthine coffee further comprises 0.01%~1% coffee oil.

11. The paraxanthine coffee of claim 1, wherein the paraxanthine coffee further comprises 0.01%~2% of medium-chain triglycerides.

12. The paraxanthine coffee of claim 2, wherein the paraxanthine is a suspension or solution.

13. The paraxanthine coffee of claim 12, wherein the paraxanthine suspension or solution comprises an appropriate binder.

14. The paraxanthine coffee of claim 12, wherein the appropriate binder is selected from one or more of pectin, xanthan gum, Carrageenan, guar gum, Arabic gum, hydroxymethyl cellulose, and hydroxypropyl methylcellulose.
